(19) United States
(12) Patent Application Publication
(10) Pub. No.: US 2001/0029760 A1
(43) Pub. Date: Oct. 18, 2001

(54) Lock mechanism

(76) Inventor: Bernard John Viney, Berkshire (GB)

Correspondence Address: Joseph R. Kelly, WESTMAN CHAMPLIN & KELLY, Suite 1600 - International Centre, 900 South Second Avenue, Minneapolis, MN, 55402-3319, US

(21) Appl. No.: 09/781,668

(22) Filed: Feb. 12, 2001

(30) Foreign Application Priority Data
Feb. 14, 2000 (GB) 0003366.2

(51) Int. Cl. E05B 47/00

(52) U.S. Cl. 70/279.1

(57) ABSTRACT

There is described a lock mechanism for fixing to one of a moveable member or frame for locking the moveable member in a closed position in the frame. The lock mechanism comprises a bolt member moveable between a disengaged position and an engaged position for engagement with the frame or moveable member. Drive means are also included for driving the bolt member between the disengaged and engaged positions. First electrical means moveable between a first position and a second position are included and are permanently coupled to the drive means by a linkage for actuating the drive means to drive the bolt member from the engaged position to the disengaged position. The lock mechanism also includes second means for actuating the drive means independently of the first electrical means, the linkage coupling the first electrical means to the drive means in such a way as to permit the drive means to drive the bolt member from the engaged position to the disengaged position in response to the actuation of the second means irrespective of the position of the first electrical means.

The present invention relates to a lock mechanism for fixing to one of a moveable member or frame for locking the moveable member in a closed position in the frame and, in particular, but not exclusively, the present invention relates to a lock mechanism which can be both electrically and manually operated.

There is a need for lock mechanisms for medium or high security applications which can be locked both electrically and manually. Such locks have particular applications in prisons and the like. A particular requirement for such applications is that the lock mechanism is able to be operated electrically to remotely unlock and lock a door whilst still allowing for the manual unlocking of the door in an emergency, for example, when there has been a power failure to the electrical drive mechanism.

One such lock mechanism which is currently available is the 120M Series of locks supplied by Folder Adam Company of 163000 W, 103 Street, Lemont, Ill. 60439, United States of America. The 120M Series locks have a latch-bolt member which extends from a latch mechanism which can be mounted on the door or the door frame to contact the other of the door frame or door. There is also provided a ball catch to detect whether the door is in the closed position. Once the door has been unlocked by the actuation of a motor, the latch-bolt is held mechanically in the retracted position. If the motor is actuated to extend the latch-bolt, the latch-bolt is still held mechanically in the retracted position until the door is opened whereupon the ball catch detects the opening of the door and the latch-bolt is released.

The lock mechanism is also provided with a cylinder key for the manual operation of the latch-bolt. Under key operation, when the door is closed the latch-bolt can be retracted and held mechanically in the retracted position. However, if the key is rotated in the opposite direction to extend the latch-bolt, the latch-bolt is held mechanically retracted until the door is opened. When the door is opened, the latch-bolt will automatically extend.

When the door is opened, the electric motor and the key mechanism can be used to retract and extend the latch-bolt.

Thus, this prior art mechanism suffers from the serious disadvantage that when the door is closed and the latch-bolt is retracted, either using the electric motor or manually using the key, it cannot be extended again until the door has been opened. The lock mechanism requires the latch-bolt to be in its extended position as the door is closed. The latch-bolt cannot be extended once the door is closed. Thus, if, for instance, in a prison environment, the motor was accidentally actuated, or, in a situation where the latch-bolt was retracted to open the door and it was necessary to quickly re-lock the door, the door must first be opened before it can be re-locked. Where the lock mechanism is normally operated remotely, this requires an individual to go to the door and carry out the opening and closing operation which is undesirable. In a high security environment in which a potentially dangerous situation might arise, for example, with a prisoner as the door is being unlocked, it would be highly advantageous to be able to immediately re-lock the door without having to open it first.

One solution to these problems is provided by the lock mechanism which forms the subject of UK Patent Nos. 2,307,270 and 2,321,277. However, although this lock mechanism meets all the operational requirements of a high security environment and is sufficiently rugged for the toughest of prisons, nevertheless its mechanisms are particularly complex and expensive to produce. Accordingly, it is desirable to provide a simpler lock mechanism which can be both electrically and manually operated but which at the same time is more economical to produce while still overcoming the disadvantages of much of the prior art.

According to the present invention there is provided a lock mechanism for fixing to one of a moveable member or frame for locking said moveable member in a closed position in said frame, the lock mechanism comprising a bolt member moveable between a disengaged position and an engaged position for engagement with said frame or moveable member; drive means for driving said bolt member between said disengaged and engaged positions; first electrical means moveable between a first position and a second position and permanently coupled to said drive means by a linkage for actuating said drive means to drive said bolt member from said engaged position to said disengaged position; and second means for actuating said drive means independently of said first electrical means, said linkage coupling said first electrical means to said drive means in such a way as to permit said drive means to drive said bolt member from said engaged position to said disengaged position in response to the actuation of said second means irrespective of the position of said first electrical means.

Advantageously, the second means for actuating the drive means may comprise a second electrical means such as an electronic key pad or the like. Alternatively, the second means for actuating the drive means may comprise manually operable means. This manually operable means may comprise a key operated device, such as a rim cylinder, or may comprise a non-lockable opening device such as a handle, a crash-bar or a break dome. Irrespective of whether the second means comprises a second electrical means or a manually operable means, it may be placed on either side of the lock, either alone or in combination with a third means placed on the opposite side of the lock. This third means may also comprise either a further electrical means or a manually operable means.

Advantageously the drive means may be permanently coupled to the bolt member. In particular, the drive means may comprise a toothed gear wheel in intermeshing engagement with a rack provided on the bolt member.

Advantageously the linkage may incorporate sufficient lost motion to permit the drive means to drive the bolt member from the engaged position to the disengaged position in response to the actuation of the second means without inducing a change in position of the first electrical means.

Advantageously, the linkage may be adapted to form a solid link between the first electrical means and the drive means in response to the actuation of the first electrical means.

Advantageously the linkage may comprise a member having a length capable of changing between a maximum and a minimum but which, when the length is a minimum, is capable of acting as a push-rod.

Advantageously the linkage may be telescopic.

Advantageously the linkage may comprise a push-rod which may be extended in length by pulling the ends of the push-rod in opposite directions.

Advantageously the linkage may be pivotally mounted at opposite ends to both the first electrical means and the drive means. Preferably the linkage is pivotally mounted with respect to the first electrical means about an axis which is substantially perpendicular to an axis about which the linkage is pivotally mounted with respect to the drive means. Preferably the pivotable mounting at at least one of these ends is adapted so as to additionally allow a degree of pivotal movement about an axis parallel to that of the other of the ends. Preferably this pivotable mounting may comprise a peg of convex cross-section received within a right cylindrical bore.

Advantageously the bolt member may be biased towards the engaged position.

Advantageously the lock mechanism may additionally comprise a restraining mechanism to engage and restrain the bolt member when the bolt member is in the disengaged position; and status detecting means for detecting when the moveable member is in a closed position in the frame, the status detecting means being coupled to the restraining mechanism to cause the restraining mechanism to release the restraint on the bolt member when the closed position is detected.

Advantageously the lock mechanism may additionally comprise a deadbolt assembly moveable between a locked position in which the bolt member is prevented from being moved from the engaged position to the disengaged position and an unlocked position in which the bolt member is not so prevented; and means for moving the deadbolt assembly from the locked position to the unlocked position in response to actuation of at least one of the first electrical means or the second means. Preferably a degree of lost motion may be provided between the cam means and the drive means so that, upon actuation of at least one of the first electrical means or the second means, the drive means does not drive the bolt member to the disengaged position until the cam means has moved the deadbolt assembly to the unlocked position. Preferably the linkage is permanently connected to the drive means via the cam means. Preferably the cam means is mounted for rotation about an axis to move the deadbolt assembly between the locked and unlocked positions, the linkage being pivotally mounted to the cam means at a location spaced from the axis.

A preferred embodiment of the present invention will now be described by way of example with reference to the accompanying drawings, in which:

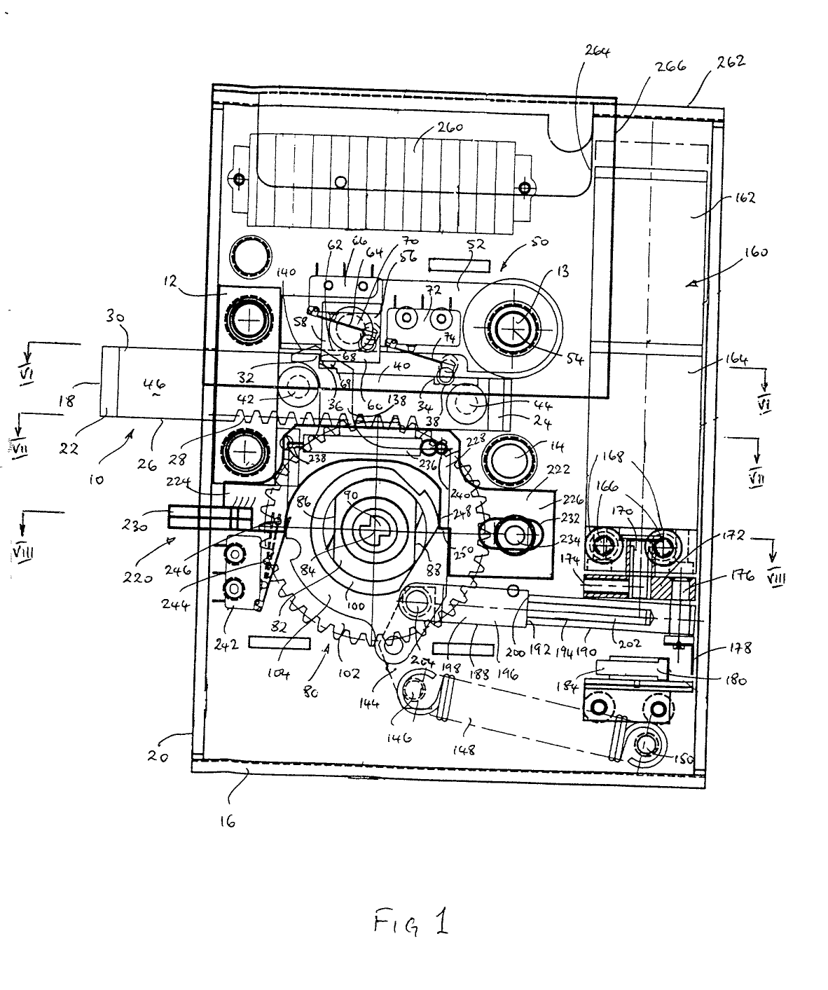

FIG. 1 is a side elevational view of a lock mechanism embodying the present invention from which a cover plate has been removed;

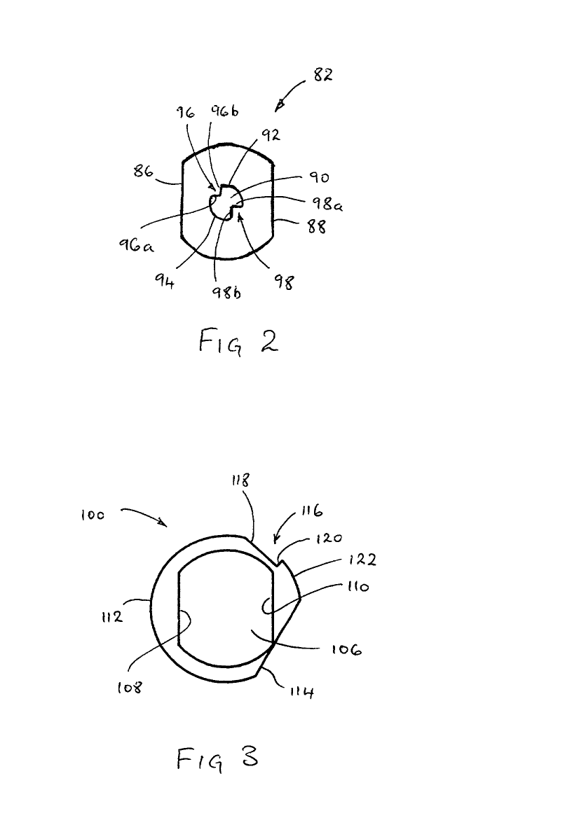

FIG. 2 is a plan view of a boss of a drive mechanism used in the lock mechanism of FIG. 1;

FIG. 3 is a plan view of a restraint cam used in the lock mechanism of FIG. 1;

FIG. 4 is a plan view of a toothed gear wheel used in the lock mechanism of FIG. 1;

FIG. 5A is a plan view of a deadbolt cam used in a lock mechanism of FIG. 1;

FIG. 5B is a side view of the deadbolt cam of FIG. 5A;

FIG. 5C is an underneath view of the deadbolt cam of FIG. 5A;

FIG. 6 is a cross-sectional view taken along line VI-VI of FIG. 1, from which certain features of the lock mechanism have been omitted for the sake of clarity;

FIG. 7 is a cross-sectional view taken along line VII-VII of FIG. 1, from which certain details of the lock mechanism have again been omitted for the sake of clarity;

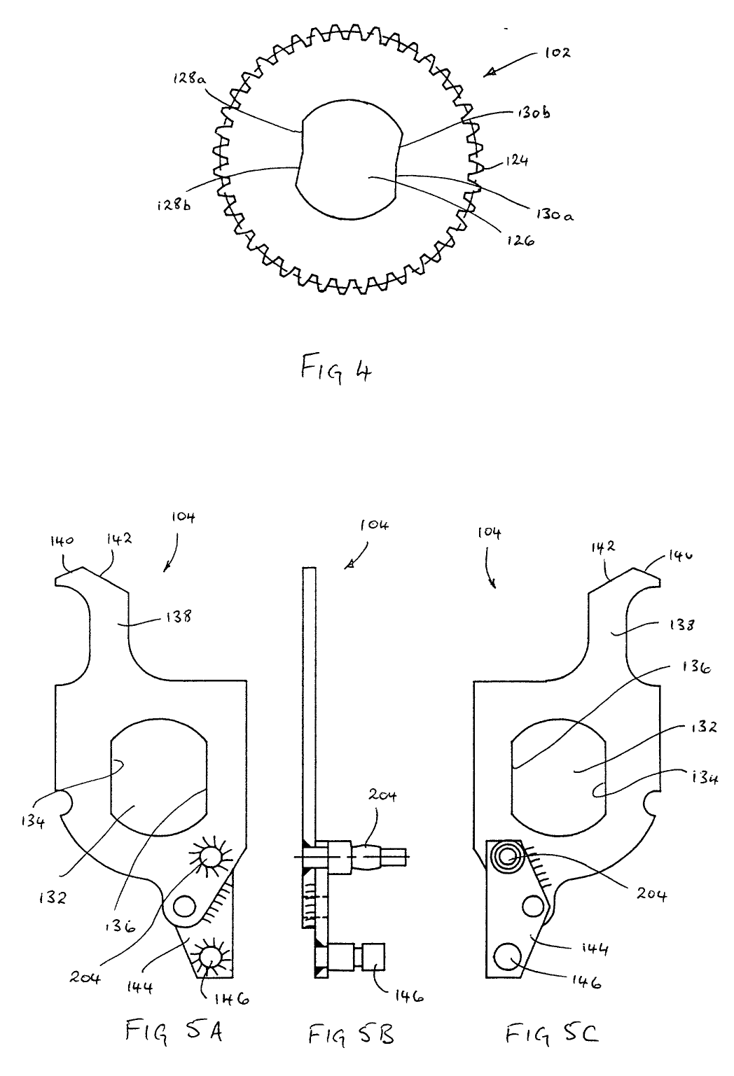

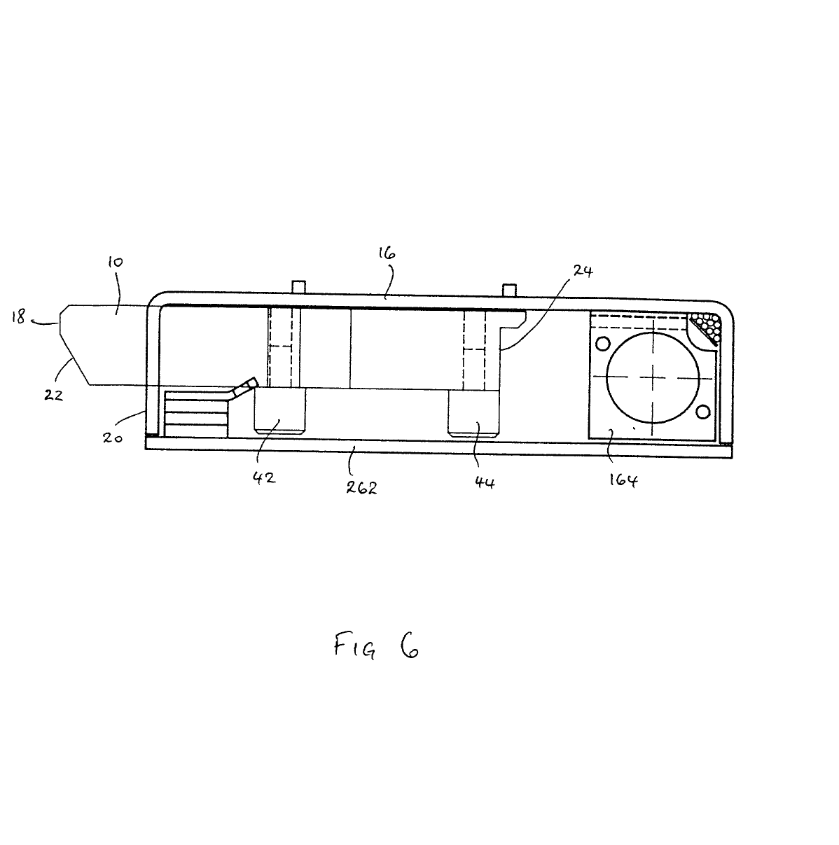

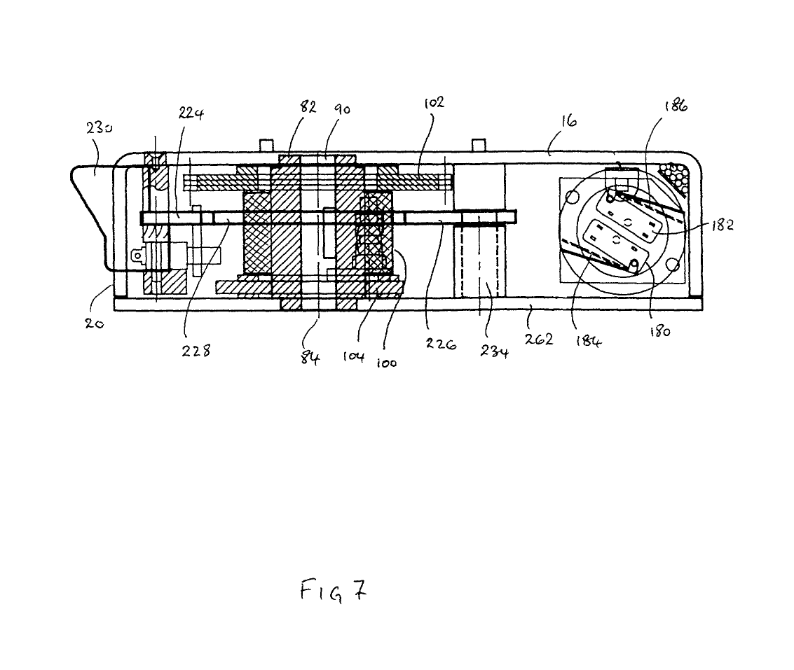

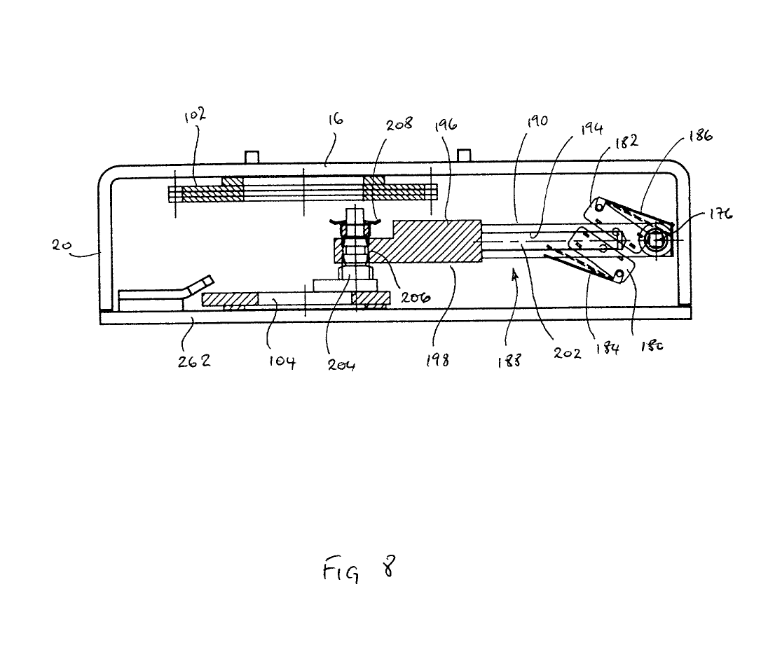

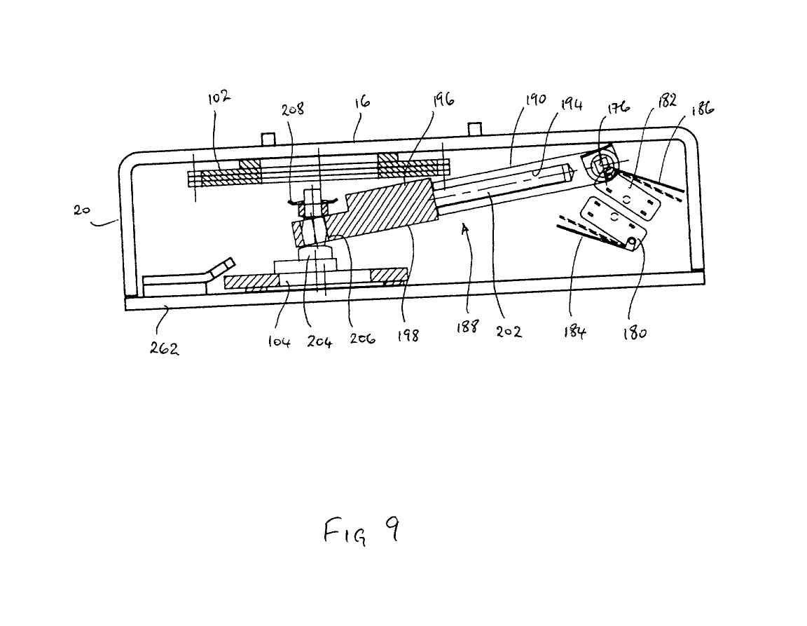

FIG. 8 is a cross-sectional view taken along line VIII-VIII of FIG. 1 from which certain details of the lock mechanism have once again been omitted for the sake of clarity;

FIG. 9 is a view similar to that of FIG. 8 but in which a depending pin joined to one end of an extendable push-rod has been rotated through 90°;

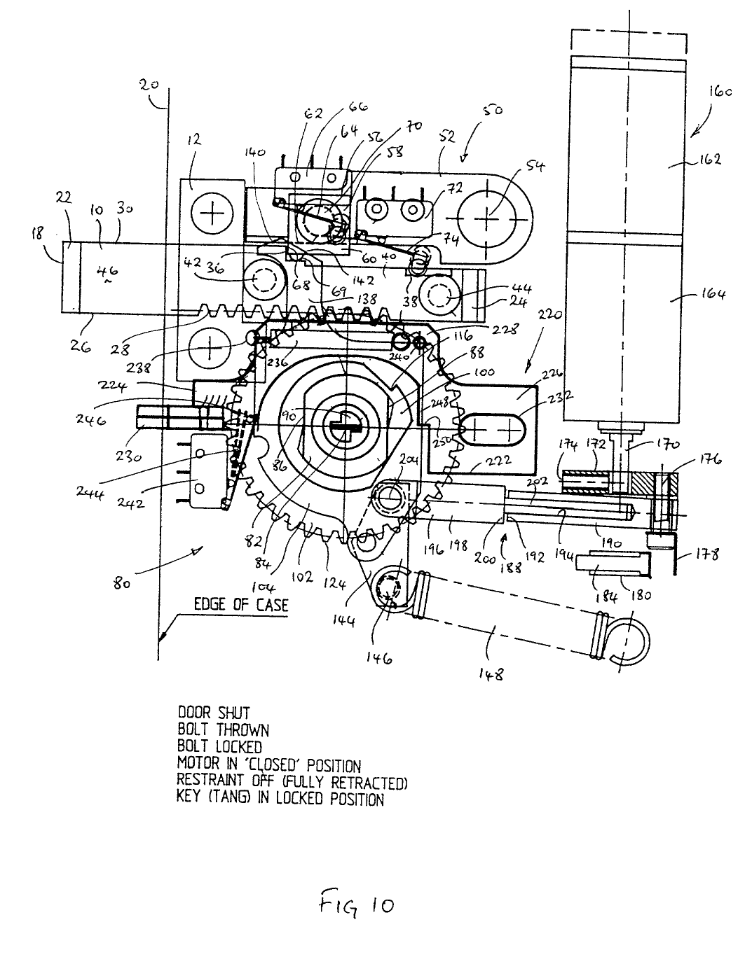

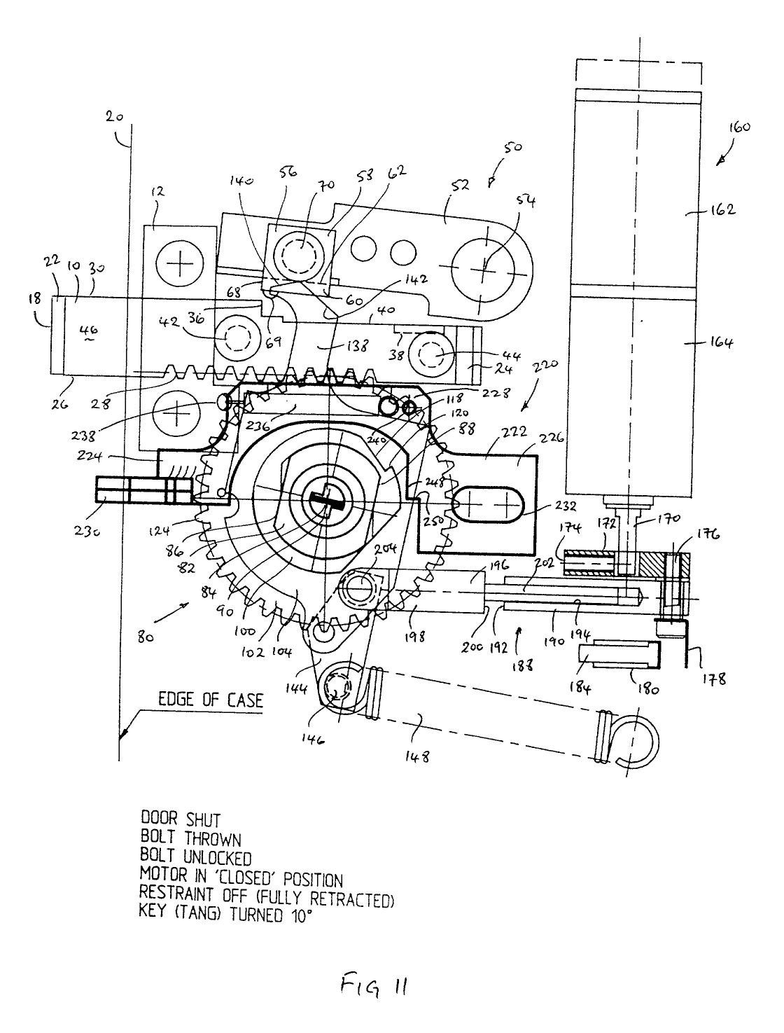

FIG. 10 shows the position of the lock mechanism when the door is closed, the bolt member is in the engaged position, the deadbolt assembly is in a locked position, the electrical drive means is in a closed position, the restraint mechanism is in a fully retracted off position and the tang is in a locked position;

FIG. 11 shows the position of the lock mechanism when the door is closed, the bolt member is in the engaged position, the deadbolt assembly is in an unlocked position, the electrical drive means is in a closed position, the restraint mechanism is in a fully retracted off position and the tang has been turned through an angle of, typically, 10°;

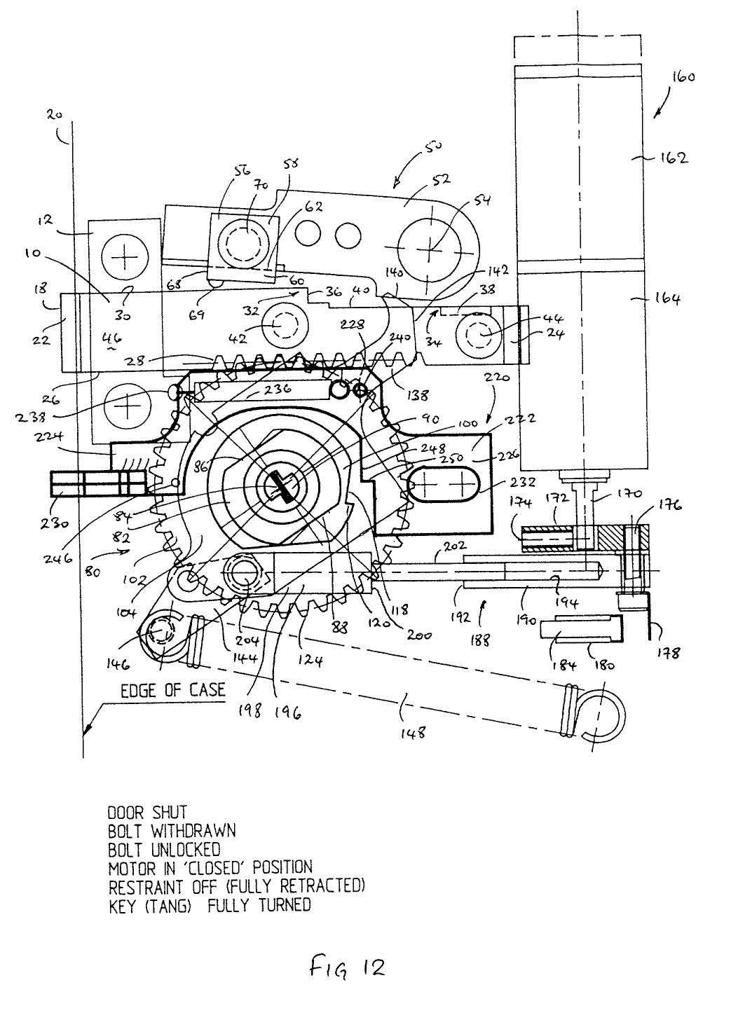

FIG. 12 shows the position of the lock mechanism when the door is closed, the bolt member is in the disengaged position, the deadbolt assembly is in an unlocked position, the electrical drive means is in a closed position, the restraint mechanism is in a fully retracted off position, and the tang has been fully turned;

FIG. 13 shows the position of the lock mechanism when the door is open, the bolt member is in the disengaged position, the deadbolt assembly is in an unlocked position, the electrical drive means is in a closed position, the restraint mechanism is in an on position and the tang has been returned to its starting position;

FIG. 14 shows the position of the lock mechanism when the door is closed, the bolt member is in the engaged position, the deadbolt assembly is in an unlocked position, the electrical drive means has been actuated and its output shaft turned through a small angle, the restraint mechanism is in a fully retracted off position and the tang is in a locked position;

FIG. 15 shows the position of the lock mechanism when the door is closed, the bolt member is in the disengaged position, the deadbolt assembly is in an unlocked position, the electrical drive means is in an open position, the restraint mechanism is in a fully retracted off position, and the tang is in a locked position;

FIG. 16 shows the position of the lock mechanism when the door is open, the bolt member is in the disengaged position, the deadbolt assembly is in an unlocked position, the electrical drive means is in a closed position, the restraint mechanism is in an on position, and the tang is in a locked position;

FIG. 17 is a plan view of boss/restraint cam combination for use in a lock mechanism embodying the present invention; and

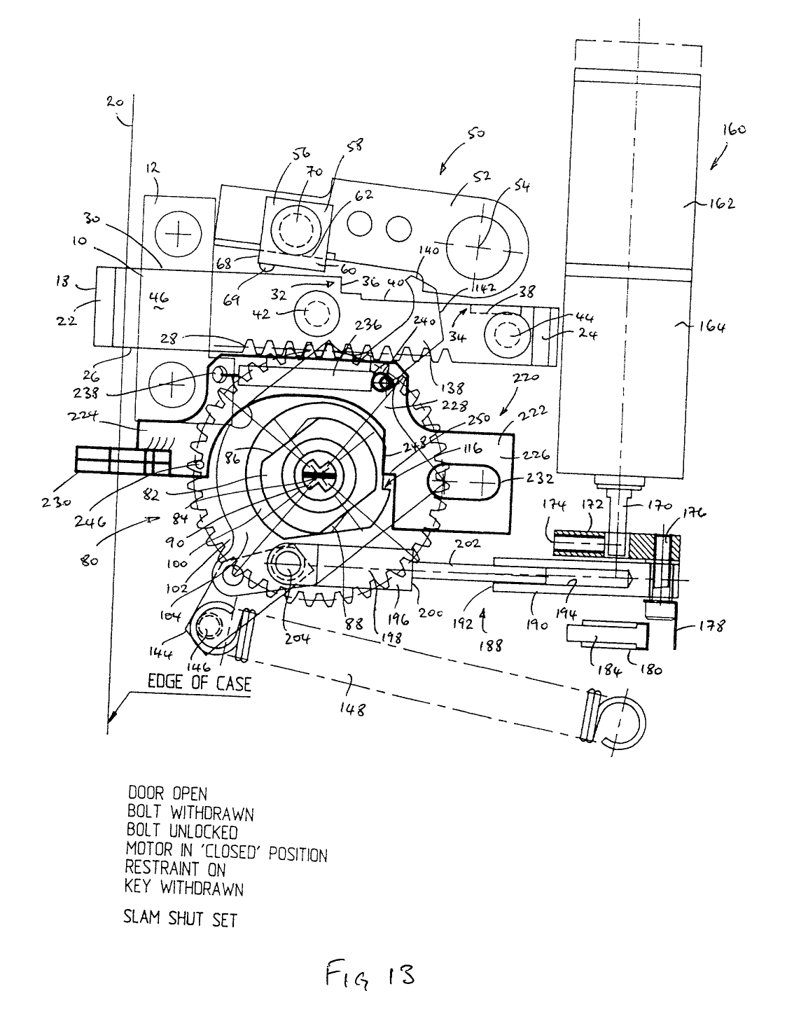

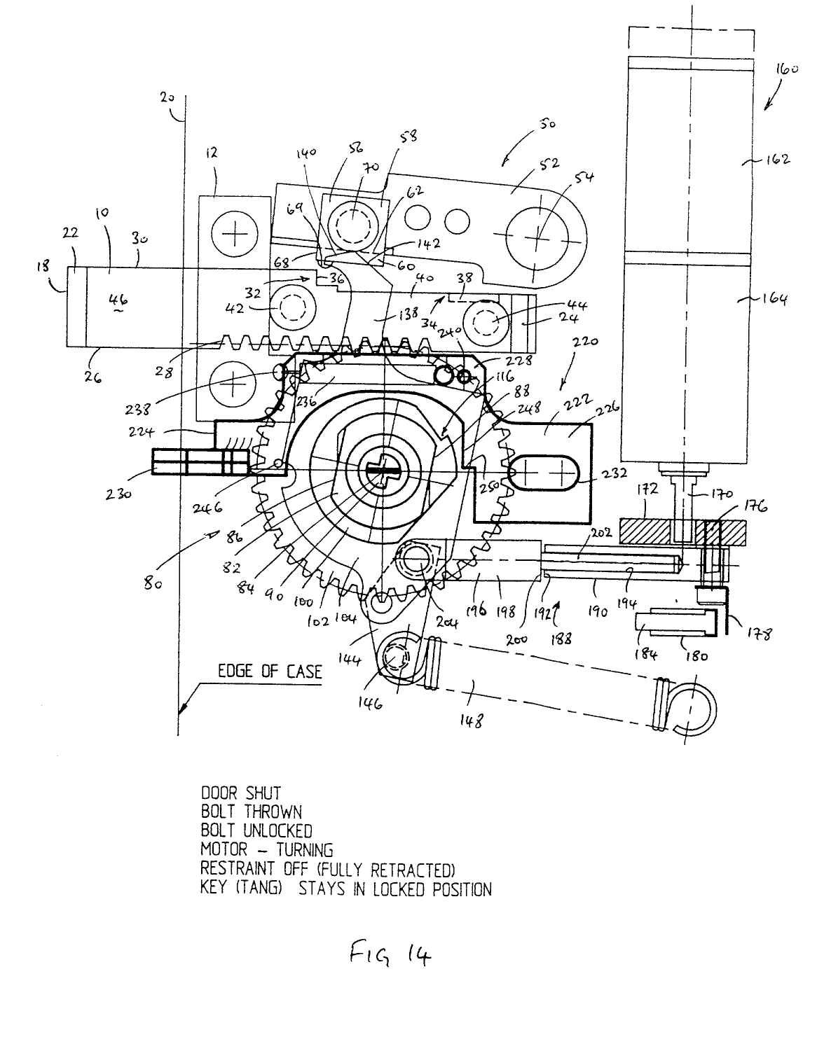

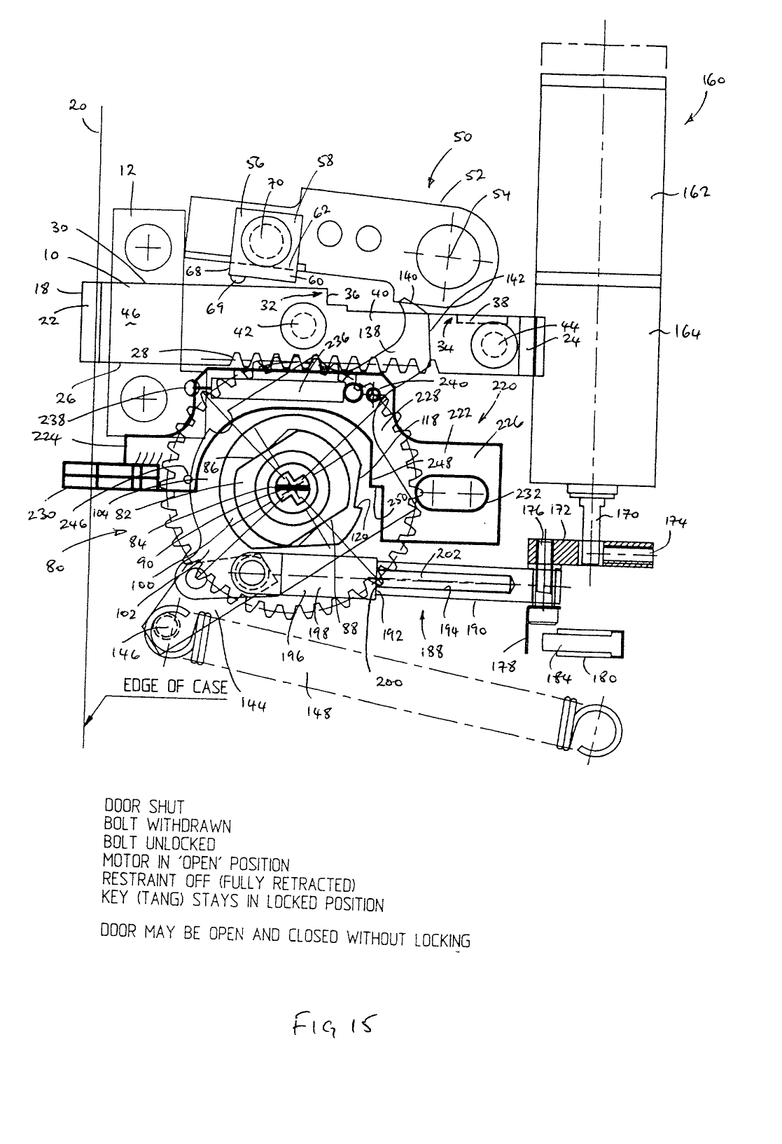

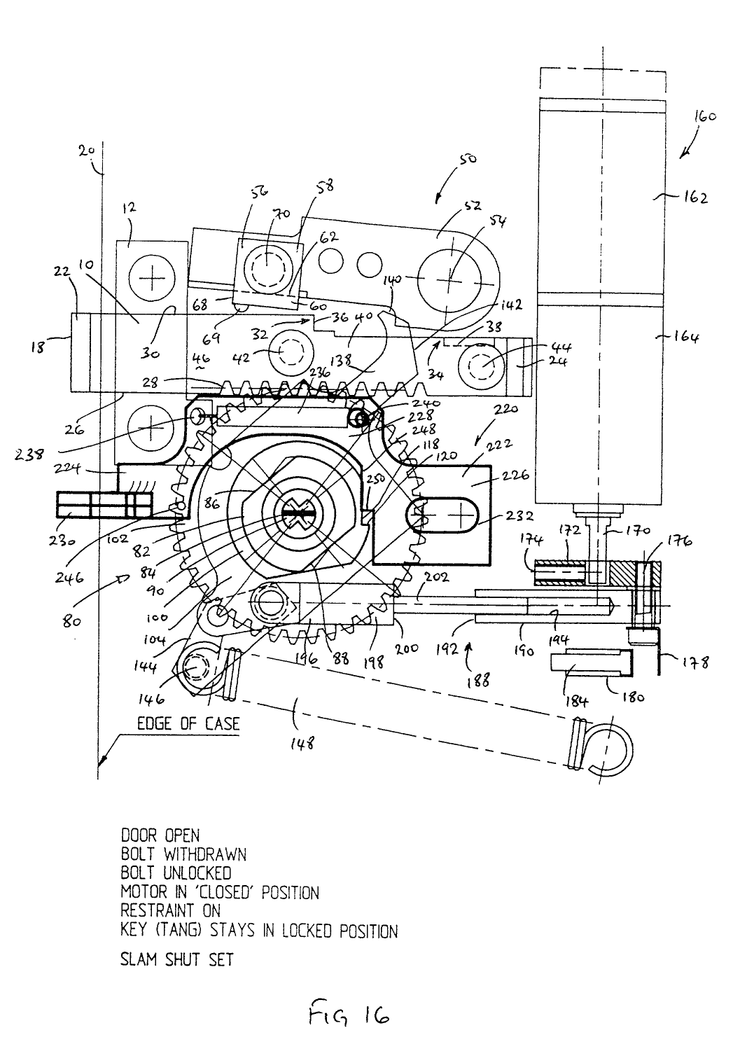

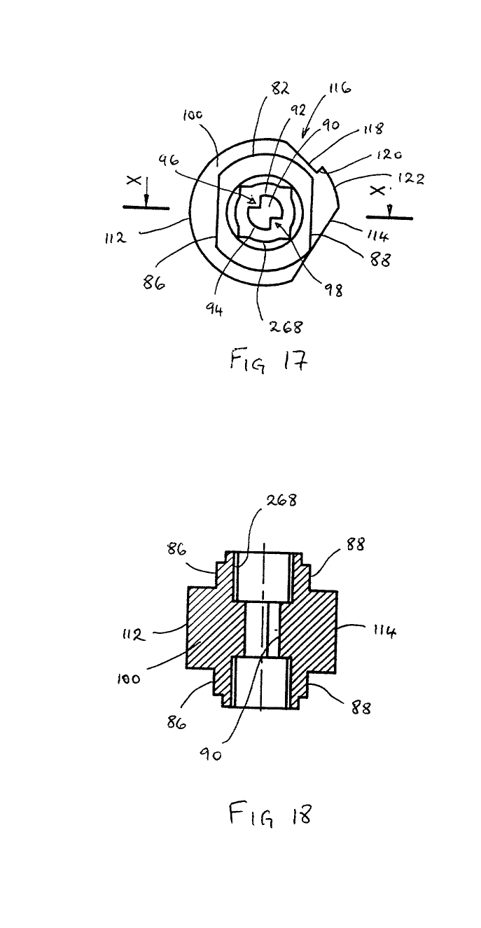

FIG. 18 is a cross-sectional view taken along line x-x of FIG. 17.

Referring to the drawings, and in particular to FIG. 1, a lock mechanism in accordance with one embodiment of the present invention is shown to comprise a bolt member 10 which is retained by a guide 12 and spacers 13 and 14 within a housing 16. The bolt member 10 is moveable translationally between an engaged position in which the bolt member extends from the housing 16, and a disengaged position in which an end surface 18 of the bolt member lies substantially flush with a side face of the housing 20. At the end of the bolt member 10 which extends from the housing 16 there is provided an angled face 22 that merges with end surface 18 to provide the bolt member with a degree of latching ability. At the opposite end, the bolt member 10 is provided with a contoured end surface 24 which is shaped so as to fit around other components within the lock when the bolt member is in the disengaged position. In this way the bolt member 10 may exhibit the maximum amount of throw while at the same time keeping the lateral dimension of the housing 16 to a minimum. At the same time the bolt member is at all times retained between spacers 13 and 14 which, with guide 12, serve to guide the movement of the bolt member.

Intermediate the end surfaces 18 and 24, the bolt member 10 is provided, on its lower surface 26, with a rack 28 and, on its upper surface 30, with first and second shoulders 32 and 34. The first shoulder 32 is defined by the intersection of the upper surface 30 with a wall 36 while the second shoulder 34 is defined by a longitudinal recess 38 in what is an already narrowed portion 40 of the bolt member as a result of the first shoulder 32. Two bosses 42 and 44 project from a side surface 46 of the bolt member, one of which, 42, is located just forward of the first shoulder 32 while the other, 44, is located adjacent the contoured end surface 24.

A deadbolt assembly 50 is located within the housing 16 above the bolt member 10 as viewed in FIG. 1. The deadbolt assembly 50 comprises an arm 52 pivotally mounted at one end about an axis 54. At an end remote from the axis 54, the arm 52 is provided with a substantially L-shaped member 56 defined by perpendicular limbs 58 and 60. Both limbs are substantially planar in shape and the first limb, 58, overlies arm 52 to which it is secured. The second limb, 60, depends from the first and extends past the arm 52 in a direction towards the back of the housing 16. In this way the second limb 60 presents an upper surface 62 beneath the arm 52 which may be contacted by an arm 64 of a micro-switch 66 to sense the position of the deadbolt assembly 50. In addition the second limb 60 also present a more extensive side surface 68 than would be presented by the first of the perpendicular limbs 58 alone and this side surface is arranged so as to be in confronting relationship with wall 36 of the bolt member 10. A domed projection 69 projects from an under surface of the second limb 60 for engagement with the bolt member 10.

In addition to the L-shaped member 56, the arm 52 of the deadbolt assembly 50 also serves to carry a boss 70. The boss 70 is mounted on the first of the perpendicular limbs 58 of the L-shaped member 56 and projects in a direction opposite to that of the second limb 60. A second micro-switch 72 is mounted to the housing 16 beneath the arm 52 in a position between the L-shaped member 56 and the axis 54 and has an arm 74 which is received within the longitudinal recess 38 of the bolt member 10. A spring (not shown) connected between the arm 52 and the housing 16 ensures that the arm, although pivotally mounted about axis 54, is biased in an anti-clockwise direction as viewed in FIG. 1.

Within the housing 16 and disposed below the bolt member 10 as viewed in FIG. 1 is a drive mechanism 80. The drive mechanism 80 comprises a boss 82 which is mounted for rotation within the housing 16 about an axis 84. Although the boss 82 has an outer peripheral shape that is substantially circular in cross-section, it is nevertheless provided with two opposing flats 86 and 88. In addition, the boss 82 has a central aperture 90 for the receipt of a tang either of a lockable device such as a key operated rim cylinder or else of a non-lockable opening device such as a handle, crash-bar or break dome. Furthermore, the central aperture 90 is adapted so as to be capable of receiving such tangs from one or both sides of the lock mechanism. As shown in the drawings, the central aperture 90 has a cross-sectional shape similar to that which would be defined by opposite ends of a rectilinear bar that is rotated through an angle of approximately 90° about a perpendicular axis passing through its center. The result is an aperture comprising two arcuate portions 92 and 94, each subtending an angle of approximately 90°, interconnected by two shoulder portions 96 and 98. Each shoulder portion is defined by two orthogonal surfaces 96a, 96b and 98a, 98b such that, in cross-section, surface 96a extends in a direction substantially parallel to that of 98a and surface 96b extends in a direction substantially parallel to that of 98b.

Working from the back of the housing 16 towards the cover plate, there is mounted on the boss 82 a toothed gear wheel 102, a restraint cam 100 and a deadbolt cam 104.

The restraint cam 100 includes a central aperture 106 which, although substantially circular, includes two opposing flats 108 and 110. The aperture 106 is sized so as to tightly receive the boss 82 with the result that the restraint cam 100 rotates with the boss. The external periphery of the restraint cam 100 includes a substantial arcuate portion 112 which merges, at one end, with an external flat 114 and, at the other, with a recessed notch 116 defined by orthogonal walls 118 and 120, wall 120 being substantially radial. The external periphery of the restraint cam 100 is completed by a further arcuate section 122 which joins wall 120 with an opposite end of the external flat 114.

By contrast, the toothed gear wheel 102 has on its peripheral surface a plurality of teeth 124 which are shaped and sized so as to mesh with the rack 28 of the bolt member 10. However, in addition to this, the gear wheel 102 is also provided with a central aperture 126 which, like that of the restraint cam 100, is substantially circular. However, unlike the restraint cam 100, rather than being provided with two opposing flats, the central aperture 126 of the gear wheel 102 is provided with two pairs of opposing surfaces 128a and 128b and 130a and 130b. Each pair of opposing surfaces subtend between them an obtuse included angle of typically 170° and are so arranged such that, in cross-section, surface 128a extends in a direction parallel to surface 130a and surface 128b extends in a direction parallel to surface 130b. Overall, the aperture 126 is sized so as to receive the boss 82 and is arranged so that, initially at least, the opposing flats of the boss 86 and 88 are engaged by opposing surfaces 128a and 130a. However, because of the obtuse angle subtended by the pairs of opposing surfaces 128a and 128b and 130a and 130b, the toothed gear wheel 102 does not rotate with the boss 82 until such time as the opposing flats of the boss 86 and 88 are rotated into engagement with surfaces 128b and 130b after which the boss 82 and gear wheel 102 rotate together.

The deadbolt cam 104 comprises a central aperture which is shaped in a manner similar to that of the restraint cam 100 so that it not only receives the boss 82 but is also provided with opposing flats 134 and 136 so that at all times the deadbolt cam 104 can rotate with the boss 82.

In addition, the deadbolt cam 104 includes, on one side of the axis 84, an upwardly projecting finger 138 which passes rearwardly of the forward boss 42 of the bolt member 10. At a distal end, the upwardly projecting finger 138 is shaped so as to terminate in oppositely inclined cam surfaces 140 and 142 which meet and subtend an obtuse included angle.

On an opposite side of the axis 84 from the upwardly projecting finger 138, the deadbolt cam 104 is also provided with a downwardly projecting extension piece 144. The downwardly projecting extension piece 144 may either be formed integrally with the deadbolt cam 104 in one piece or else may comprise a separate element which is joined to the deadbolt cam, by welding or the like, so as to rotate with it. In any event, at a distal end, the downwardly projecting extension piece 144 is provided with a pin 146 which projects towards the back of the housing 16 and serves as an anchor for one end of a spring 148, the opposite end of which is anchored by a second pin 150 mounted on the housing 16.

Disposed within the housing 16 and to the rear of both the bolt member 10 and the drive mechanism 80 as viewed in FIG. 1 is an electrical drive means 160 comprising an electric motor 162 and a co-axially mounted gear box 164. The electric motor 162 and gear box 164 are retained in position within the housing 16 by means of a plurality of threaded fasteners, such as screws 166, which are received within correspondingly threaded apertures 168. An output shaft 170 protrudes from the gear box 164 and is connected at an end remote from the gear box to a circular disc 172 having a diameter substantially equal to the lateral dimension of the electrical drive means 160. The disc 172 may be retained on the output shaft 170 by any suitable means but, in particular, may be held in place by the receipt of a screw 174 within a radial bore within the thickness of the disc that communicates with a corresponding aperture in a distal end of the output shaft. The electric motor 162 and gear box 164 are adapted so that, upon actuation of the electric motor, the circular disc 172 is caused to rotate about the longitudinal axis of the output shaft 170.

An eccentrically mounted depending pin 176 projects from a surface of the circular disc 172 remote from the gear box 164 and carries at its distal end a downwardly projecting finger 178 for interaction with a pair of micro-switches 180 and 182. The micro-switches 180 and 182 are mounted to the casing 16 and arranged in back-to-back formation with their respective arms 184 and 186 facing in substantially opposite directions. In addition to the downwardly projecting finger 178, the depending pin 176 also carries one end of an extendable push-rod 188 which is pivotally mounted with respect to the depending pin. The push-rod 188 comprises two parts. The first part 190 is of elongate construction extending generally towards the drive mechanism 80 and, as well as being pivotally mounted with respect to the depending pin 176 at one end, is, at the other end, provided with an end surface 192 in which there is provided a blind axial bore 194. The second part of the push-rod 196 is similarly elongate and comprises a body portion 198 having one end pivotally connected to the deadbolt cam 104 while the opposite end terminates in end surface 200. An axially extending pin 202 projects from the end surface 200 and is slidably received within the blind axial bore 194 of the first part of the push-rod 190.

As shown in more detail in FIGS. 7 and 8, the body portion 198 is pivotally connected to the deadbolt cam 104 by means of a depending peg 204 carried by the deadbolt cam and which projects towards the back of the housing 16. The depending peg 204 is received within a throughbore 206 within the body portion 198 which extends generally perpendicularly to the longitudinal axis of the push-rod 188. The body portion 198 is retained on the depending peg 204 by means of a collar 208. This allows the push-rod 188 to pivot about an axis passing through the depending peg 204 but in addition, in order to provide a degree of pivotable movement about an axis perpendicular to that, the depending peg 204 is shaped so as to be of convex cross-section with a central portion of the peg being of greater diameter than either of the two ends.

A restraint mechanism 220 is also provided within the housing 16 and comprises a substantially planar restraint member 222 having a forward portion 224 and a rear portion 226 interconnected by a substantially arcuate portion 228. At the forward portion 224, the restraint member 222 is joined to a tongue 230 which, although substantially planar, occupies a plane substantially perpendicular to that of the restraint member. By contrast, the rear portion 226 is provided with a longitudinal slot 232 in which is received a pin 234 mounted to the casing 16. A spring 236 is mounted between the restraint member 222 and the housing 16 with one end of the spring being anchored by means of a suitable aperture 238 provided in the guide 12 while the other end is anchored to the arcuate portion of the restraint member 228 by means of projecting peg 240. As a result, although capable of translational movement between an extended on position, in which the tongue 230 protrudes from the housing 16, and a retracted off position, in which the tongue is substantially flush with side face 20, the restraint member 222 is biased towards the extended on position. Nevertheless, in order to sense the true position of the restraint member 222, a further mircro-switch 242 is mounted to the housing 16 close to side face 20 where its arm 244 can engage a second pin 246 which projects from the forward portion of the restraint member 224 towards the back of the housing 16.

In order to improve the stability of the restraint mechanism 220, the tongue 230 and the longitudinal slot 232 are provided on opposite sides of the boss 82 and at substantially the same height within the housing 16 as the axis 84. Accordingly, the arcuate portion 228 is shaped, where it merges with the forward portion 224, so as to avoid contact with the boss 82 in either the extended or retracted positions of the restraint mechanism. However, in contrast to this, where the arcuate portion 228 merges with the rear portion 226, a shoulder is formed defined by orthogonal surfaces 248 and 250.

Thus, the present lock mechanism comprises a number of micro-switches, each having three terminal leads. For ease of use these leads are channelled, together with those for actuation of the electric motor 162, to a wiring block 260 located in an upper portion of the housing 16 as viewed in FIG. 1. Conveniently a top plate 262 for the housing 16 may be provided which includes a recess 264 which allows access to the wiring block 260 without exposing the remainder of the lock mechanism. This recess 264 may in turn be concealed by a cover plate 266. In this way, when the lock mechanism is first fitted, only the cover plate 266 need be removed to enable the necessary electrical connections to be made to the lock.

Having described the construction of the lock mechanism, its method of operation will now also be discussed with reference to a door moveable within a frame. It will be understood however that the lock mechanism is equally applicable to any moveable leaf.

FIG. 10 shows the lock mechanism in a state in which the door with which the mechanism is associated is closed, the bolt member 10 is in the engaged position, the deadbolt assembly 50 is in a locked position, the electrical drive means 160 is in what may be termed a closed position, the restraint mechanism 220 is in a fully retracted off position, and the tang received within the central aperture 90 of boss 82 is in a locked position. Looking at the figure in more detail, the bolt member 10 extends from the housing 16 having been urged into this position by spring 148 which acts on the deadbolt cam 104 to rotate the boss 82 in an anti-clockwise direction in the figure as shown, thereby causing opposing flats 86 and 88 to engage opposing surfaces 128a and 130a and rotate gear wheel 102 in a similar, anti-clockwise direction. This movement, coupled with the intermeshing engagement of teeth 124 with the rack 28 causes the bolt member 10 to move to the engaged position. In this position the protruding portion of the bolt member 10 is received within an aperture or recess provided within a socket plate (not shown) located in the opposite of the frame or door depending to which the lock mechanism is mounted. Further forward movement of the bolt member 10 is prevented by the engagement of boss 42 with the guide 12 while rearward movement of the bolt member is prevented by the deadbolt assembly 50 where side surface 68 of the second limb of the L-shaped member 56 engages wall 36. The L-shaped member 56 is retained in this position by means of the spring (not shown) which urges the arm of the dead lock assembly 52 in an anti-clockwise direction as viewed in FIG. 10. The end force protection provided by the deadbolt assembly 50 is particularly advantageous where the lock mechanism finds use in high security installations such as prisons.

In the state shown in FIG. 10 the electrical drive means 160 is so arranged that the depending pin 176 is disposed at its furthest point from the drive mechanism 80 and it is this position that defines the minimum length of the extendable push-rod 188 although, for the sake of clarity, the two parts 190 and 196 have been shown slightly separated so that there is a small gap between the two end surfaces 192 and 200.

Because in the state shown in FIG. 10 the door is closed, the restraint mechanism 220 is urged rearwardly against the action of spring 236 by virtue of the engagement of the tongue 230 with an opposing portion of the socket plate (not shown) into which or through which the projecting portion of the bolt member 10 is received. As a consequence, the pin 234 takes up a position towards the left hand end of the longitudinal slot 232.

From the position shown in FIG. 10 the lock mechanism may be operated to withdraw the bolt (ie to move the bolt member 10 translationally from its engaged position to its disengaged position) by either electrical or mechanical means. Describing the mechanical means first, upon rotation of a tang within the central aperture 90, boss 82 is caused to rotate by the engagement of the tang with shoulder portions 96a and 98a. For the first 10° or so of rotation only the restraint cam 100 and the deadbolt cam 104 rotate with the boss 82. The toothed gear wheel 102 does not co-rotate with the boss 82 until such time as the opposing flats 86 and 88 are brought into engagement with opposing surfaces 128b and 130b. Accordingly, there is provided a degree of lost motion during which the deadbolt cam 104 rotates but the toothed gear wheel 102 does not. As the deadbolt cam 104 rotates, the inclined cam surface 142 at the distal end of the upwardly projecting finger 138 is brought into engagement with the boss 70 projecting from the first limb 58 of the L-shaped member 56. As the deadbolt cam 104 continues to rotate, the arm 52 of the deadbolt assembly 50 is pivoted about axis 54 in a clockwise direction as viewed in FIG. 10 with the result that side surface 68 is withdrawn from its confronting relationship with wall 36 of the bolt member 10.

FIG. 11 shows the state of the lock mechanism when the lost motion inherent in the shape of the central aperture 126 of the gear wheel 102 has been used up and the opposing flats 86 and 88 of the boss 82 are brought into engagement with opposing surfaces 128b and 130b. The deadbolt cam 104 has rotated clockwise under the urging of the tang within the central aperture 90 and against the action of spring 148 which was extended as a result. The restraint cam 100 has also rotated with the boss 82 but the gear wheel 102 has not. As a result, the bolt member 100 has not moved and remains in the engaged position. As explained previously, the deadbolt assembly 50 has moved and the point of engagement between the upwardly projecting finger 138 and the boss 70 has now reached the apex defined by oppositely inclined cam surfaces 140 and 142. This movement of the deadbolt assembly 50 is detected by the micro-switch 66, the arm of which 64 is in contact with the upper surface 62 of the second limb 60 of the L-shaped member 56.

In moving from the state shown in FIG. 10 to that shown in FIG. 11 the electric motor 162 has not been energised and so remains in what may be termed a closed position. However, since the deadbolt cam 104 has been rotated, depending peg 204 has moved further away from depending pin 176 and push-rod 188 has had to extend in order to accommodate this. This extension is achieved by the partial sliding of pin 202 out of the blind axial bore 194 so that there is now an increased gap between end surfaces 192 and 200 of the two parts of the push-rod.

Because the door has not yet been opened the restraint mechanism 220 remains in a fully retracted off position.

As the tang continues to be rotated within the central aperture 90, the gear wheel 102 is gathered up and co-rotates with not only the boss 82 but also the restraint cam 100 and the deadbolt cam 104. This rotation of the gear wheel in what, when viewed in FIG. 11, is a clockwise direction causes the bolt member 10 to move toward the disengaged position by virtue of the intermeshing engagement of teeth 124 with the rack 28. It will be noted that this rearward movement of the bolt member 10 is no longer prevented by the interengagement of side surface 68 and wall 36 since the arm 52 of the deadbolt assembly 50 has been pivoted out of the way so that these two surfaces are no longer in confronting relationship. Micro-switch 72 detects the rearward movement of the bolt member 10 since in so doing the arm of the micro-switch 74 is removed from its engagement with the longitudinal recess 38, is pivoted upwardly by virtue of its engagement with the second shoulder 34 and slides along an upper surface of the narrowed portion of the bolt member 40.

The rearward movement of the bolt member 10 may be limited by a stop or by the engagement of the contoured end surface 24 with the electrical drive means 160 or by selecting the rack 28 to be of a suitable length. In any event, the rearward movement of the bolt member 10 is preferably arrested when the end surface 18 is substantially flush with side face 20. This is the position shown in FIG. 12 in which the door remains shut but the bolt member 10 has been withdrawn to a disengaged position. At the same time, the continued rotation of the deadbolt cam 104 has caused the point of engagement between the upwardly projecting finger 138 and the boss 70 to slide along inclined cam surface 140, thereby lowering the arm 52 of the deadbolt assembly 50 back into contact with the upper surface 30 of bolt member 10 under the action of the spring (not shown). However, by this stage the bolt member 10 has been moved sufficiently that the shoulder 32 is positioned rearwardly of the L-shaped member 56 and can no longer engage the side surface 68. As the upwardly projecting finger 138 moves away from the boss 70, the continued sliding engagement between the bolt member 10 and the deadbolt assembly 50 is facilitated by domed projection 69 which additionally prevents the micro-switch 66 from resetting once the arm 52 has been lowered.

On the other side of the axis 84, the rotation of deadbolt cam 104 continues to extend spring 148 which reaches its maximum length when the bolt member 10 is in its disengaged position. At the same time the depending peg 204 continues to rotate away from depending pin 176 and, once again, the two parts of the push-rod 190, 196 move apart to accommodate this while at the same time retaining at least a distal portion of pin 202 within axial bore 194.

As with the situation shown in FIG. 11, because the door has not been opened and because the electric motor 162 has not been actuated, the restraint mechanism 220 and the electrical drive means 160 remain in their previous positions.

The door, although still closed, has had the bolt member withdrawn and may now be opened. Alternatively, if the person unlocking the door changes their mind and wishes to return the lock mechanism to its original state, this may be achieved by simply releasing the means used to rotate the tang within the aperture 90, whether it be a lockable device such as a key operated rim cylinder or a non-lockable device such as a handle, crash-bar or break dome. The lock mechanism will then return to the state shown in FIG. 10 via the state shown in FIG. 11 under the action of spring 148 which will also re-establish the lost motion in the toothed gear wheel 102. The key, if there be a key, may then be removed from the lock. However, if, with the lock mechanism in the state shown in FIG. 12, the door is opened a slam lock situation is set up as shown in FIG. 13.

In FIG. 13 the door has been opened, allowing the restraint mechanism 220 to move from a retracted off position to an extended on position under the action of spring 236 in which tongue 230 protrudes from side face 20 and longitudinal slot 232 takes up a position to the left of pin 234. This movement of the restraint member 222 to the extended position is sensed by micro-switch 242, the arm of which 244 is pivoted by the forward movement of second pin 246. At the same time the shoulder defined by orthogonal surfaces 248 and 250 is brought into close proximity with that defined on the restraint cam 100 by recessed notch 116. If the tang is now allowed to rotate counter-clockwise under the ultimate action of spring 148, wall 120 of the recessed notch 116 is brought into engagement with surface 250 of the restraint member 222, thereby preventing further rotation of the restraint cam 100 and, with it, further rotation of boss 82, gear wheel 102 and deadbolt cam 104.

In moving from the situation shown in FIG. 12 to that shown in FIG. 13 the state of many of the other components of the lock mechanism do not change significantly. There is however, initially at least, a small anti-clockwise rotation of the boss 82 with the result that the toothed gear wheel 102 also rotates slightly causing the end surface 18 of the bolt member 10 to protrude slightly from side face 20. However, this slight protrusion of the bolt member 10 does not prevent the door from ultimately being closed as a result of the provision of angled face 22 which on closing is the first to engage the socket plate (not shown) and serves to latch the bolt member into a position in which it can then be extended.

The slight rotation of boss 82 also causes the restraint cam 100 to rotate, moving the upwardly projecting finger 138 closer to but not into engagement with boss 70 and allowing spring 148 to retract slightly in length. The push-rod 188 also retracts slightly as depending peg 204 moves back towards depending pin 176 and pin 202 slides within axial bore 194.

The key, if there is a key, may now be withdrawn from the lock and access gained to the space previously closed by the locked door. However, the next time the door is closed within the frame, the lock mechanism will return to the state shown in FIG. 10 notwithstanding the absence of a key should one have been provided previously. When the door closes the tongue 230 of the restraint mechanism 220 is once again engaged by the socket plate (not shown) provided on the other of the door or frame depending to which the lock mechanism is mounted. The restraint mechanism 220 is urged rearwardly to its retracted off position against the action of spring 236. In so doing the longitudinal slot 232 once again takes up a position to the right of pin 234 and orthogonal surfaces 248 and 250 are moved out of engagement with walls 118 and 120 of the recessed notch 116. In the absence of such an engagement the restraint cam 100 is free to rotate under the action of spring 148 together with boss 82, toothed gear wheel 102 and deadbolt cam 104. The rotation of gear wheel 102 causes the bolt member 10 to be driven towards the engaged position by virtue of the intermeshing engagement of teeth 124 with rack 28. At the same time the rotation of the deadbolt cam 104 moves the upwardly projecting finger 138 back into engagement with boss 70 which slides up cam surface 140 to lift arm 52 away from the upper surface 30 of the bolt member 10 before then sliding down the oppositely inclined cam surface 142 to lower side surface 68 back into confronting relationship with wall 36. On the other side of axis 84, the rotation of the deadbolt cam 104 brings depending peg 204 back towards depending pin 176, thereby enabling the extendable push-rod 188 to take up a position in which pin 202 is substantially fully received within axial bore 194 and end surfaces 192 and 200 are in close, if not actual, contact with each other. Since the spring 148 is able, in the final part of its retraction, to re-establish the lost motion between the boss 82 and the toothed gear wheel 102, the lock mechanism, on undergoing a slam lock, moves sequentially from the state shown in FIG. 13 to that shown in FIG. 11 and from there to that shown in FIG. 10.

As previously stated, the lock mechanism may also be operated using the electrical drive means 160. Thus, starting with the lock mechanism in the state shown in FIG. 10, the electric motor 162 may be actuated so as to rotate the circular disc 172 via the gear box 164 and output shaft 170. This rotation is sensed by micro-switch 180 the arm of which 184 is engaged by downwardly projecting finger 178. As the circular disc 172 rotates, so depending pin 176 moves to the left as viewed in FIG. 10. As it does so, the two parts of the push-rod 188 move closer together until such time as the end surface 192 of the first part 190 bears against that of the body portion 198. Thereafter, with no further collapse of the push-rod possible, the rotation of the circular disc 172 and the depending pin 176 causes the push-rod 188 to push the deadbolt cam 104 via depending peg 204. Because depending pin 176 is spaced from the axis 84, this in turn causes the deadbolt cam 104 to rotate, together with boss 82 and restraint cam 100, against the action of spring 148. As with the manual operation, during the initial rotation of the boss 82 the toothed gear wheel 102 remains stationary with the result that the deadbolt 10 is also stationary. The gear wheel 102 is only gathered up and rotates with the restraint cam 100 and deadbolt cam 104 once the boss 82 has been rotated through an angle sufficient to bring opposing flats 86 and 88 into engagement with opposing surfaces 128b and 130b. By then however, as previously explained, the deadbolt cam 104 has rotated through an angle sufficient to bring the upwardly projecting finger 138 into engagement with the boss 70 of the deadbolt assembly 50. Indeed, by the time that the toothed gear wheel 102 has been gathered up the boss 70 has risen up the cam surface 142 causing the arm 52 of the deadbolt assembly 50 to pivot upwardly against the action of the spring (not shown), thereby removing side surface 68 of the second limb 60 of the L-shaped member 56 from its confronting relationship with wall 36 of bolt member 10. Once again, this pivotal movement of the deadbolt assembly is sensed by micro-switch 66. This then is the situation shown in FIG. 14 in which the door is closed, the bolt member 10 is in the engaged position, the deadbolt assembly 50 has been pivoted to an unlocked position and the electric motor 162 has turned through a small but nonetheless significant angle. Because the door is closed the restraint mechanism 220 is held in a fully retracted off position against the action of spring 236 by virtue of the engagement of tongue 230 with a socket plate (not shown) provided on the other of the frame or door depending to which the lock mechanism is mounted. Because the tang received within the central aperture 90 has played no part in moving from the state shown in FIG. 10 to that shown in FIG. 14, it also has not moved, the aperture rotating around the tang so that the tang is no longer in engagement with shoulder portions 96 and 98.

As the circular disc 172 continues to rotate the depending pin 176 moves towards a position spaced 180° from that shown in FIG. 10. On route to this position the push-rod 188, which joins the circular disc 172 to the deadbolt cam 104, continues to cause the deadbolt cam to rotate and with it the boss 82. Rotation of the boss 82 in turn causes rotation of the restraint cam 100 and, now that the lost motion has been gathered up, also the rotation of the toothed gear wheel 102. As the toothed gear wheel 102 rotates the bolt member 10 is moved rearwardly towards a disengaged position by virtue of the intermeshing engagement of teeth 124 and the rack 28. As before, it will be noted that the bolt member 10 is no longer prevented from moving in this rearward direction by the interengagement of side surface 68 and wall 36 since the deadbolt assembly 50 has been pivoted out of the way before the bolt member 10 starts to move. Once again the movement of the bolt member 10 is sensed by micro-switch 72. As before the rearward movement of the bolt member 10 may be arrested either by the provision of a suitable stop, or by the engagement of the contoured end surface 24 with the electrical drive means 160 or by careful selection of the length of the rack 28.

As the deadbolt cam 104 continues to rotate it not only does so against the action of spring 148, causing the spring to extend, but it also causes boss 70 to ride down inclined cam surface 140. This in turn serves to lower the arm 52 of the deadbolt assembly 50 back into engagement with the bolt member 10 under the action of the spring (not shown) before the upwardly projecting finger 138 is then rotated away. As the bolt member 10 moves rearwardly towards its disengaged position it is therefore in sliding contact with the deadbolt assembly 50 and this sliding contact is facilitated by domed projection 69 located on a lower surface of the second limb 60 of L-shaped member 56. The domed projection 69 also prevents the micro-switch 66 from resetting once the arm 52 has been lowered. This then is the situation shown in FIG. 15 in which the door is still closed, the bolt member 10 is in the disengaged position, the deadbolt assembly 50 is in an unlocked position and the electric motor 162 has caused the circular disc 172 to be rotated to what might be termed as an open position in which depending pin 176 is spaced 180° from the so called closed position of FIG. 10. Because the door has not yet been opened the restraint mechanism 220 has remained in its fully retracted off position while, similarly, the tang received in the central aperture 90 has also not been moved.

With the lock mechanism in the state shown in FIG. 15 the door may be opened to provide access to the space that was previously closed. However, in so doing, no slam lock is established enabling the door to be opened and closed at will. All that happens on opening the door is that the restraint mechanism 220 is free to move, under the action of spring 236, to an extended position since the tongue 230 is no longer restrained by engagement with a socket plate. However, even though the restraint member 220 moves to the left as viewed in FIG. 15, it does not act to restrain the bolt member 10 since the bolt member is already “restrained” by the action of push-rod 188 which holds boss 82, restraint cam 100, toothed gear wheel 102 and deadbolt cam 104 in their fully rotated positions against the action of spring 148. If the door is subsequently closed the restraint mechanism 220 simply returns to its fully retracted off position (as shown in FIG. 15) against the action of spring 236 by virtue of the re-engagement of tongue 230 with the socket plate (not shown). As previously explained, the movement of the restrain mechanism 220 is sensed by micro-switch 242.

Should it be desired to establish a slam lock using the electrical drive means 160, all that is required, once the door has been opened, is to actuate electric motor 162 to rotate circular disc 170 for a further 180°. This further rotational movement is sensed by micro-switch 182 the arm of which 186 is engaged by downwardly projecting finger 178. As a result of the rotation of the circular disc 170, the depending pin 176 is returned to its initial closed position in which the push-rod 188 is no longer capable of holding the deadbolt cam 104 and boss 82 against the action of spring 148. However, if the door has been opened, rather than returning to the state shown in FIG. 10, the lock mechanism takes up the configuration shown in FIG. 16. The restraint mechanism 220 moves to an extended position under the action of spring 236 and, in so doing, brings orthogonal surfaces 248 and 250 into engagement with the recessed notch 116 of the restraint cam 100 which, like the toothed gear wheel 102 and deadbolt cam 104 have been rotated by boss 82 under the action of the push-rod 188. This engagement between orthogonal surface 250 and wall 120 of the recessed notch 116 prevents the restraint cam 100 from returning to its initial position under the action of spring 148 and, at the same time, prevents rotation of boss 82, toothed gear wheel 102 and deadbolt cam 104. Because of this, in order for the depending pin 176 to return to its starting position, push-rod 188 must extend and it does so by the partial sliding withdrawal of pin 202 from axial bore 194 which enables the two parts of the push-rod 190 and 196 to move apart.

This then is the position shown in FIG. 16. If the door is now closed, the restraint member 222 will be forced to move to the right against the action of spring 236 by virtue of the engagement of the tongue 230 with the socket plate (not shown). This will move orthogonal surface 250 out of engagement with wall 120 of the recessed notch 116, freeing the restraint cam 100 to rotate anti-clockwise under the action of spring 148. This in turn will cause rotation of boss 82 and with it the toothed gear wheel 102 and the deadbolt cam 104. The rotation of the gear wheel 102 and the intermeshing engagement of teeth 124 with the rack 28 causes the bolt member 10 to be driven towards the engaged position while the rotation of deadbolt cam 104 once again brings the upwardly projecting finger 138 into engagement with boss 70. The boss 70 initially slides up inclined cam surface 140, lifting the deadbolt assembly 50 out of engagement with bolt member 10, before then sliding down the oppositely inclined cam surface 142 which lowers the arm 52 of the deadbolt assembly so that the side surface 68 of the second limb 60 is once again in confronting relationship with wall 36. At the same time, on the opposite side of axis 84, depending peg 204 moves back towards depending pin 176 which is permitted by the sliding receipt of pin 202 within axial bore 194. The end result is that the lock mechanism returns to the state shown in FIG. 10.

It will be apparent from the foregoing description that the extendable push-rod 188 is pivotally mounted at opposite ends about axes which are mutually orthogonal. Accordingly, not only does the push-rod 188 have to accommodate movement within the plane of FIG. 1 but also in a plane perpendicular to that which is at its maximum when the depending pin 176 has been rotated through 90° or 270° from its starting position. This is the situation shown in FIG. 9. In order to accommodate this movement, the depending peg 204 is formed so as to be of convex shape when viewed in cross-section even though the throughbore 206 in which it is received defines a right cylinder. As a result the push-rod 188 is able to pivot about depending peg 204 within the plane of FIG. 9 sufficiently to allow the unimpeded rotation of depending pin 176.

The described lock mechanism thus provides a means whereby a bolt member can be moved between its engaged and disengaged positions either electrically or mechanically while the moveable member with which the lock mechanism is associated is in a closed position. Furthermore, the lock mechanism may be either surface mounted or fore-end mounted.

Whilst the restraint cam 100 and the deadbolt cam 104 have been described as comprising separate components from the boss 82, it will be apparent to those skilled in the art that since both cams at all times rotate with the boss, then one or both of them may be formed integrally therewith. In FIGS. 17 and 18, for example, there is shown an arrangement in which the restraint cam 100 is formed integrally with boss 82.

In addition, and again as shown in FIGS. 17 and 18, the central aperture 90 of the boss 82 may be provided with a profiled recess 268 for the receipt of a siege handle so that, under a siege condition, sufficient torque may be applied from one side of the lock mechanism to rotate the boss and unlock the door.

1. A lock mechanism for fixing to one of a moveable member or frame for locking said moveable member in a closed position in said frame, the lock mechanism comprising
a bolt member moveable between a disengaged position and an engaged position for engagement with said frame or moveable member;
drive means for driving said bolt member between said disengaged and engaged positions;
first electrical means moveable between a first position and second position and permanently coupled to said drive means by a linkage for actuating said drive means to drive said bolt member from said engaged position to said disengaged position; and
second means for actuating said drive means independently of said first electrical means, said linkage coupling said first electrical means to said drive means in such a way as to permit said drive means to drive said bolt member from said engaged position to said disengaged position in response to the actuation of said second means irrespective of the position of said first electrical means.

2. A lock mechanism in accordance with claim 1, wherein said second means for actuating said drive means comprises second electrical means.

3. A lock mechanism in accordance with claim 1, wherein said second means for actuating said drive means comprises manually operable means.

4. A lock mechanism in accordance with claim 3, wherein said manually operable means comprises a key operated device.

5. A lock mechanism in accordance with claim 3, wherein said manually operable means comprises a non-lockable opening device.

6. A lock mechanism in accordance with claim 1, wherein said drive means is permanently coupled to said bolt member.

7. A lock mechanism in accordance with claim 6, wherein said drive means comprises a toothed gear wheel in intermeshing engagement with a rack provided on said bolt member.

8. A lock mechanism in accordance with claim 1, wherein said linkage incorporates sufficient lost motion to permit said drive means to drive said bolt member from said engaged position to said disengaged position in response to the actuation of said second means without inducing a change in position of said first electrical means.

9. A lock mechanism in accordance with claim 1, wherein said linkage is adapted to form a solid link between said first electrical means and said drive means in response to the actuation of said first electrical means.

10. A lock mechanism in accordance with claim 1, wherein said linkage comprises a member having a length capable of changing between a maximum and a minimum but which, when the length is a minimum, it is capable of acting as a push-rod.

11. A lock mechanism in accordance with claim 1, wherein said linkage is telescopic.

12. A lock mechanism in accordance with claim 1, wherein said linkage comprises a push-rod which may be extended in length by pulling the ends of the push-rod in opposite directions.

13. A lock mechanism in accordance with claim 1, wherein said linkage is pivotally mounted at opposite ends to both said first electrical means and said drive means.

14. A lock mechanism in accordance with claim 13, wherein said linkage is pivotally mounted with respect to said first electrical means about an axis which is substantially perpendicular to an axis about which said linkage is pivotally mounted with respect to said drive means.

15. A lock mechanism in accordance with claim 14, wherein the pivotal mounting at at least one of said ends is adapted so as to additionally allow a degree of pivotal movement about an axis parallel to that of the other of said ends.

16. A lock mechanism in accordance with claim 15, wherein said pivotal mounting at at least one of said ends comprises a peg of convex cross-section received within a right cylindrical bore.

17. A lock mechanism in accordance with claim 1, wherein said bolt member is biased towards said engaged position.

18. A lock mechanism in accordance with claim 1, wherein said lock mechanism additionally comprises
a restraining mechanism to engage and restrain said bolt member when said bolt member is in said disengaged position; and
status detecting means for detecting when said moveable member is in a closed position in said frame, said status detecting means being coupled to said restraining mechanism to cause said restraining mechanism to release the restraint on said bolt member when said closed position is detected.

19. A lock mechanism in accordance with claim 1, wherein said lock mechanism additionally comprises
a deadbolt assembly moveable between a locked position in which said bolt member is prevented from being moved from said engaged position to said disengaged position and an unlocked position in which said bolt member is not so prevented; and
cam means for moving said deadbolt assembly from said locked position to said unlocked position in response to actuation of at least one of said first electrical means or said second means.

20. A lock mechanism in accordance with claim 19, wherein a degree of lost motion is provided between said cam means and said drive means so that, upon actuation of at least one of said first electrical means or said second means, said drive means does not drive said bolt member to said disengaged position until said cam means has moved said deadbolt assembly to said unlocked position.

21. A lock mechanism in accordance with claim 20, wherein said linkage is permanently connected to said drive means via said cam means.

22. A lock mechanism in accordance with claim 21, wherein said cam means is mounted for rotation about an axis to move said deadbolt assembly between said locked and unlocked positions, said linkage being pivotally mounted to said cam means at a location spaced from said axis.
